(19) United States
(12) Patent Application Publication
(10) Pub. No.: US 2009/0121576 A1
(43) Pub. Date: May 14, 2009

(54) METHOD FOR INSERTING A COIL IN A POLYPHASE ROTATING ELECTRICAL MACHINE STATOR, AND ASSOCIATED STATOR

(75) Inventors: Denis Even, Paris (FR); Jean-Pierre Chochoy, Cremarest (FR)

Correspondence Address: Matthew R. Jenkins;Jacox, Meckstroth & Jenkins, 2310 Far Hills Building, Dayton, OH, 45419-1575, US

(73) Assignee: Valeo Equipements Electriques Moteur, Creteil Cedex (FR)

(21) Appl. No.: 11/722,006

(22) PCT Filed: Dec. 12, 2005
(86) PCT No.: PCT/FR05/03105

§ 371 Date: Jun. 18, 2007

(30) Foreign Application Priority Data
Dec. 20, 2004 (FR) 0413610

(51) Int. Cl. H02K 15/085; H02K 3/12

(52) U.S. Cl. 310/208; 29/596

(57) ABSTRACT

A method for inserting a corrugated coil in an alternator stator, the coil comprising a number of wires, each designed to form around the inner surface of an assembly of plates a spiral including a number of turns corresponding each to one turn of the inner surface. The method includes forming each wire, the latter being configured into a succession of recesses comprising two lateral branches designed to be inserted each into a slot; and inserting the turns of each wire into a series of slots of the stator, the turns of the various wires being radially superimposed in a predetermined sequence.

### FIELD OF THE INVENTION

The invention concerns in general rotary electrical machines of the polyphase type, such as alternators or alternator/starters for motor vehicles.

More precisely, the invention concerns, according to a first aspect, a method of inserting a corrugated coil in a stator of a rotary electrical machine, such as an alternator or an alternator/starter for a motor vehicle, the stator comprising a packet of metal sheets with a central hole and having an axis of symmetry and recesses passing through axially provided in a radially internal face of the packet of metal sheets, the coil comprising a plurality of phase windings each consisting of at least one electrically conductive continuous wire, each wire being intended to form, around the internal face of the packet of metal sheets, a spiral comprising several turns each corresponding to a turn of the internal face, the method comprising the following steps:

forming each winding, each wire thereof being conformed in a succession of crenellations connected by connection segments, each crenellation comprising two lateral branches opposite each other intended each to be inserted in a recess, and a head branch connecting the two lateral branches (step referenced below “step 1/”);

inserting the turns of each wire in a series of recesses in the stator, the turns of the various wires being superimposed radially in a predetermined order (step referenced below “step 3/”).

### PRIOR ART

Methods of this type are known from the prior art, in particular through the patent document FR 2 608 334. Each phase, after shaping, is placed on an insertion tool and then inserted in the recesses in the packet of metal sheets. The insertion is performed phase by phase.

The stators formed by this method have very dense coil ends on the two sides of the packet of metal sheets, offering high resistance to the circulation of air. In addition, the coil ends are not symmetrical, one of the coil ends having an axial height greater than that of the other coil end, which is also unfavourable for the circulation of cooling air for these coil ends.

Moreover, the filling ratio of the recesses, that is to say the ratio between the cross-section of the bare conductive wire, usually made from copper, and the complete cross-section of the recess in which there is mounted a recess insulator acting between the edges of the recesses and the wires, is limited to 50%, since the positioning of the lateral branches in the recesses is not well controlled during the transfer of the turns from the insertion tool to the recesses.

In addition, the forces necessary for inserting the conductive wires in the recesses is very high. The phase inserted last must in fact push the previously inserted phases. The forces are not well transmitted from one phase to another. Under certain conditions, this may impair the quality of the product.

In this context, the aim of the present invention is to mitigate the defects mentioned above.

### OBJECT OF THE INVENTION

To this end, the method of the invention, also in accordance with the generic definition given to it by the above preamble, is essentially characterised in that the wires of all windings are inserted in the recesses at the same time, the turns of the different wires alternating in the predetermined superimposition order.

In one possible embodiment of the invention the superimposition order comprises a succession of identical sequences, each sequence consisting of a turn of each wire.

Preferably, the recesses offer a plurality of radially stepped reception positions, the lateral branches of the turns being superimposed from inside to outside in the said predetermined order progressively occupying radially more external reception positions in the recesses.

According to an advantageous characteristic of the invention, the lateral branches of one and the same crenellation are substantially straight and mutually parallel.

Advantageously, the head branches of the crenellations are curved and form a coil end on a first axial side of the stator.

Likewise, the connection segments connect two respective lateral branches of two adjoining crenellations along the wire and have a curved shape, these segments forming a coil end on a second axial side of the stator opposite to the first.

According to an advantageous characteristic of the invention, the head branches and/or the connection segments formed at step 1/ have heights increasing or decreasing along the wires.

In this case, the turns whose lateral branches are inserted in radially external positions of recess bottoms have head branches and/or connection segments with heights relatively greater than the turns whose lateral branches are inserted at radially internal positions.

According to yet another advantageous characteristic of the invention, the method can comprise, after step 3/, a step 4/ of forming the coil ends by inclining the connection segments and/or head branches inwards.

Alternatively, it can comprise, after step 3/, a step 4/ of forming the coil ends by inclining the connection segment and/or head branches outwards.

Moreover, it should be noted that the method can comprise, after step 1/, a step 1′/ of local shaping of the wire in areas of this wire intended to cross other wires, or other areas of the same wire, once the windings have been inserted in the stator.

In this case, the local shaping of the wire consists of locally deforming the cross-section of the wire, or locally curving the wire.

Advantageously, the local shaping is carried out by pinching, swaging or knurling.

According to yet another advantageous characteristic of the invention, the wire can have a round cross-section, the recesses having a circumferential width that is a multiple of the diameter of the wire.

In one possible embodiment of the invention, the recesses have a circumferential width corresponding to the diameter of the wire, the lateral branch occupying the radially innermost position being deformed by broadening in a circumferential direction so as to hold the lateral branches occupying the other positions inside the recess.

In another possible embodiment of the invention, the recesses have a circumferential width equal to at least two diameters of the wire and have on a radially internal side an opening partially closed off on two opposite sides by two axial steps, the lateral branches occupying the recesses being held inside it by a flat shim in abutment on the steps on an internal side of the recess.

In this case, the shim is formed from a plastics material containing a magnetic material, in particular iron.

Preferably, the opening has a circumferential width equal to the diameter of the wire increased by a clearance of less than 0.6 millimetres.

In addition, the recesses can have a radial depth that is a multiple of the diameter of the wire.

According to yet another advantageous characteristic of the invention, the method can comprise, between steps 1/ and 3/, the following step 2/:

2/ fitting the wires of all the windings on a cylindrical insertion tool, the turns of the wires coiling around the insertion tool and being superimposed radially from inside to outside in the said predetermined order.

In this case, on the insertion tool, the crenellations extend in respective planes parallel to the axis of symmetry of the insertion tool, or slightly inclined with respect to this axis.

In one possible embodiment of the invention, step 3/ of inserting the windings in the recesses is carried out by moving the insertion tool along the axis of symmetry of the stator.

In another possible embodiment of the invention, step 3/ of inserting the windings in the recesses is carried out by disposing the insertion tool at the centre of the packet of metal sheets and forcing the turns radially in the recesses from inside to outside.

In this case, the insertion tool comprises a plurality of radial slots formed on a radially external face of the tool and extending in respective radial planes regularly distributed around the axis of symmetry of the tool, a plurality of blades disposed in the radial slots, and means of moving the blades radially from inside to outside in the radial slots, the lateral branches of the turns coming to be inserted in the radial slots at step 2/ on a radially external side of the blades, the blades being moved radially towards the outside at step 3/ so as to transfer the lateral branches from the radial slots into the recesses.

Advantageously, the radial slots are equal in number to the number of recesses.

Preferably, each radial slot has a circumferential width corresponding to the cross-section of the wire, so that the lateral branches are all aligned radially in the slot.

For example, at step 1/, after shaping of the wires of the windings in a succession of longitudinally aligned crenellations, the wires of all the windings are stacked flat on a rectilinear longitudinal rack in which mutually parallel transverse slots are formed, the lateral branches of crenellations of each wire coming to be inserted in a series of transverse slots.

In this case, at step 2/, the stack formed by the wires of the windings is wound from the rack around the insertion tool.

In the case where the coil comprises six wires distributed in three pairs, the position of the turns of a wire in a given pair can advantageously be deduced from the position of the turns of the other winding of the same pair by a rotation corresponding to shift of one recess.

Likewise, the position of the turns of the wires in a pair can advantageously be deduced from the position of the turns of the wires in another pair by a rotation corresponding to a shift of two or four notches.

According to a second aspect, the invention concerns a stator for a polyphase rotary electrical machine, such as an alternator or an alternator/starter for a motor vehicle, this stator comprising a packet of metal sheets with a central hole and having an axis of symmetry, recesses passing through axially provided in a radially internal face of the packet of metal sheets and a winding comprising a plurality of phase windings each consisting of at least one electrically conductive continuous wire, each wire forming around the internal face of the packet of metal sheets a spiral comprising several turns each corresponding to one turn of the internal face;

each wire being conformed in a succession of crenellations connected by connection segments, each crenellation comprising two lateral branches facing each other each coming to be inserted in a recess, and a head branch connecting the two lateral branches;

the turns of the wires being superimposed radially in a predetermined order;

characterised in that the turns of the various wires alternate in a predetermined order of superimposition.

Advantageously, the predetermined order of superimposition comprises a succession of identical sequences, each sequence consisting of a turn of each wire.

Preferably, the recesses offer a plurality of radially stepped reception positions, the lateral branches of the turns being superimposed from inside to outside in the said predetermined order progressively occupying reception positions regularly more external in the recesses.

According to an advantageous characteristic of the invention, the lateral branches of each crenellation are substantially straight and mutually parallel.

Advantageously, the head branches of the crenellations are curved and form a coil end on a first axial side of the stator.

Likewise, the connection segments connect two respective lateral branches of two adjoining crenellations along the wire and have a curved shape, these segments forming a coil end on a second axial end of the stator opposite to the first.

For example, the connection segments and/or the head branches constituting the coil ends can be inclined towards the inside.

Alternatively, the connection segment and/or head branches constituting the coil ends can be inclined towards the outside.

According to another advantageous characteristic of the invention, the wire is shaped locally in areas of this wire crossing other wires or other areas of this same wire.

In this case, the local shaping of the wire consists of locally deforming the cross-section of the wire, or locally curving the wire.

Preferably, the local shaping is carried out by pinching, swaging or knurling.

According to yet another advantageous characteristic of the invention, the wire has a round cross-section, the recesses having a circumferential width that is the multiple of the diameter of the wire.

In one possible embodiment of the invention, the recesses have a circumferential width corresponding to the diameter of the wire, the lateral branch occupying the radially innermost position being deformed by broadening in a circumferential direction so as to hold the lateral branches occupying the other position inside the recess.

In another possible embodiment of the invention, the recesses have a circumferential width equal to at least two diameters of the wire and have on a radially internal side an opening partially closed off on two opposite sides by two axial steps, the lateral branches occupying the recesses being held inside it by a flat shim in abutment on the steps on an internal side of the recess.

In this case, the shim is formed from a plastics material containing a magnetic material, in particular iron.

In addition, the opening can have a circumferential width equal to the diameter of the wire plus a clearance of less than 0.6 millimetres.

Preferably, the recesses can have a radial depth that is a multiple of the diameter of the wire.

In the case where the winding comprises six wires distributed in three pairs, the positions of the turns of a wire in a given pair can advantageously be deduced from the position of the turns of the other wire in the same pair by a rotation corresponding to a shift of one recess.

Likewise, the position of the turns of the wires in a pair can be deduced from the position of the turns of the wires in another pair by a rotation corresponding to a shift of two or four recesses.

### BRIEF DESCRIPTION OF THE FIGURES

Other characteristics and advantages of the invention will emerge clearly from the description that is given of it below, by way of indication and in no way limitingly, with reference to the accompanying figures, among which:

FIGS. 1A and 1B are axial views of part of a stator, respectively obtained in accordance with the method of the prior art and in accordance with the method of the invention,

FIGS. 2A and 2B are views in perspective of the stators of FIGS. 1A and 1B,

FIG. 3 is a developed schematic representation of a wire of a phase winding of the stator of FIGS. 1B and 2B after shaping at step 1/,

FIG. 4 is a developed schematic representation of three wires of the stator of FIGS. 1B and 2B showing the crossing zones of these three windings in the stator after insertion, the circles indicating the local shaping zones,

FIG. 5 is a side view of the insertion tool after the wires are placed on this tool at step 2/, for a first embodiment of the invention.

FIG. 6 is a perspective view in the direction of the arrow VI in FIG. 5,

FIGS. 7A and 7B are schematic representations illustrating the step 3/ of insertion of the turns in the stator, for the first embodiment of the invention in which the insertion is formed by axial movement of the insertion tool,

FIG. 8 is a side view of the packet of metal sheets and of the insertion tool at step 3/ for the first embodiment,

FIG. 9 is a perspective view in the direction of the arrow IX in FIG. 8,

FIG. 10 is a schematic side view of a stator obtained in accordance with the invention,

FIGS. 11A, 11B and 11C are schematic representations of sections respectively of a recess of a stator of the invention with a width corresponding to a wire diameter, to two wire diameters and of a recess of the stator of the prior art,

FIG. 12 is an outline diagram showing the superimposition of turns of various wires around the insertion tool,

FIG. 13 is an outline diagram showing the superimposition of the turns in the packet of metal sheets,

FIG. 14 is a plan view showing the phase windings on the rack at the end of step 1/ for a second embodiment of the invention,

FIG. 15 is a side view of the rack, in the direction of the arrow XV of FIG. 14,

FIG. 16 is a view along the axis of symmetry of the insertion tool during step 2/, for the second embodiment of the invention,

FIG. 17 shows the insertion tool of FIG. 16 at the end of step 2/,

FIG. 18A is a view in a radial direction of the insertion tool of FIG. 17 disposed at the centre of the packet of metal sheets, at the start of step 3/,

FIG. 18B is a view in the direction of the arrow XVIII of FIG. 18A,

FIG. 19 is a view similar to that of FIG. 18B, showing the state at the end of step 3/,

FIG. 20 is a half view in axial section of the insertion tool of FIGS. 17 to 19 showing a blade of the tool retracted on a radially internal side on the left-hand half of the figure, and a blade partially moved towards the outside on the right-hand half,

FIG. 21 is a half-view in section of the tool in FIG. 20, in a plane perpendicular to the axis of symmetry of this tool, considered in the direction of the arrows XXI of FIG. 20, and

FIG. 22 is a side view, in a radial direction, of a stator obtained by means of the method of the invention.

### EXAMPLE EMBODIMENTS OF THE INVENTION

The insertion method is adapted to a corrugated coil 50 to be inserted in a stator 1 for an alternator or alternator/starter for a motor vehicle.

The stator 1 comprises a cylindrical packet of metal sheets 10 having an axial axis of symmetry 20 (FIG. 10), and axial recesses 30 formed in a radially internal face 11 of the packet of metal sheets 10. The recesses 30 are separated from one another by axial ribs 35 referred to as teeth (FIGS. 11A, 11B).

These recesses 30 pass axially right through the packet of metal sheets 10 with a central hole since they extend over the entire axial length of the packet of metal sheets 10 and are open radially on an internal side and the two opposite axial ends.

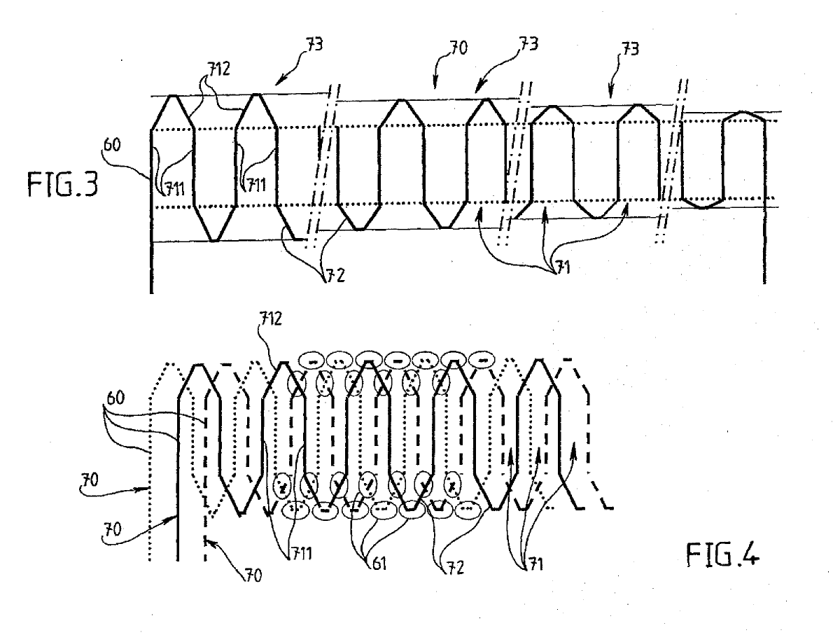

The coil 50 comprises a plurality of phase windings 70 each consisting of at least one electrically conductive continuous wire 50 (FIGS. 3 and 4). The wire is for example made from copper covered with an insulator such as enamel.

The phase windings 70 generally comprise a single wire, or two parallel wires (see FIG. 15 for example) whose respective entry ends are mutually connected electrically and whose respective exit ends are also mutually connected electrically.

In a known fashion, a recess insulator, visible in FIG. 2B, is interposed between the wires and the edge of the recesses.

The method comprises the following steps.

1/ Shaping of each winding 70, each wire 60 thereof being conformed in a succession of crenellations 71 connected by connection segments 72, as illustrated in FIG. 3. Each crenellation 71 comprises two lateral branches 711 facing each other intended each to be inserted in a recess 30, and a head branch 712 connecting the two lateral branches 711.

3/ Insertion of each winding 70 in the stator, so that the lateral branches 711 are disposed in a series of recesses 30 in the stator 1, the head branches 712 and the connection segments 722 forming coil ends 40 and 40′ respectively of first and second axial sides of the stator 1.

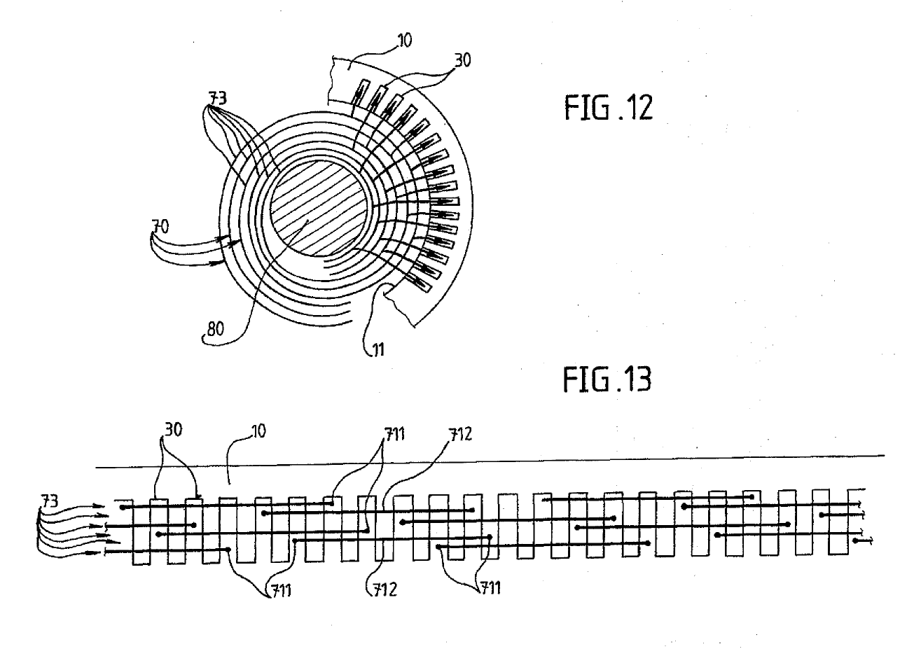

The recesses 30 are divided into several series generally each associated solely with a given wire 60. The recesses in one and the same series are distributed regularly around the stator 1, the positions of the series of recesses 30 associated with the various wires being deduced from another by an angular offset of one recess, as shown by FIGS. 12 and 13.

A wire 60 can also be distributed in several series with different recesses.

Each wire 60 is wound in a spiral around the internal face of the packet of metal sheets 10 and thus forms several turns 73 each corresponding to a turn of the internal face. These turns 73 are coaxial with the axis of symmetry 20 of the stator.

The turns 73 of the various wires 60 are superimposed radially in a predetermined order, and are disposed in the recesses 30 in a concentric fashion, the turns 73 inserted first being disposed radially towards the outside in the bottom of the recesses, and the turns 73 inserted last being disposed radially towards the inside of the packet of metal sheets 10 at the opening of the recesses.

The recesses 30 each offer a plurality of reception positions for the radially staged lateral branches 711.

The lateral branches 711 of a turn 73 of a given wire 60 are inserted in the series of recesses 30 corresponding to the said wire.

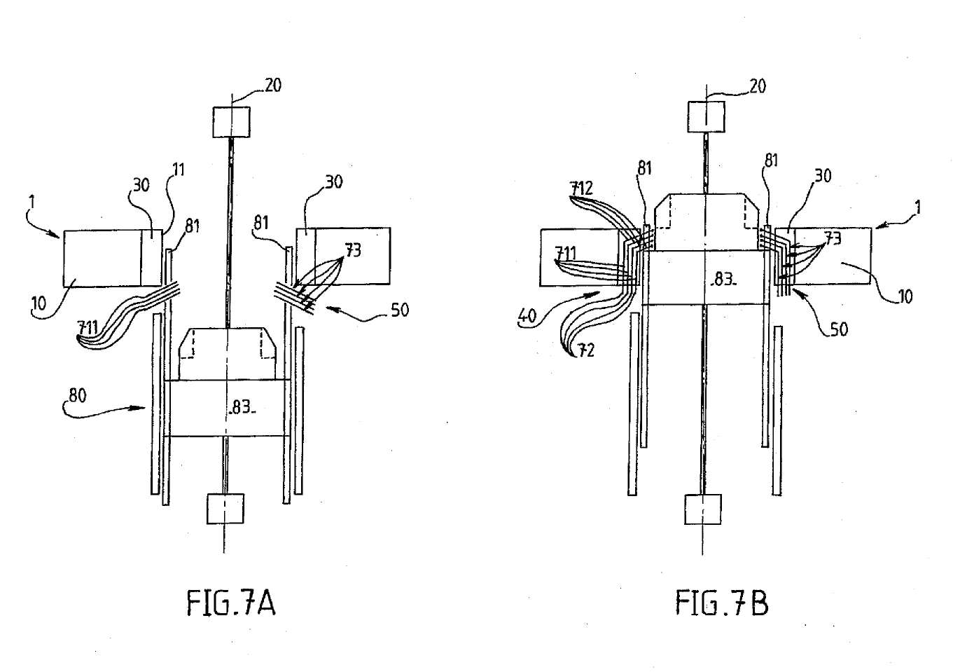

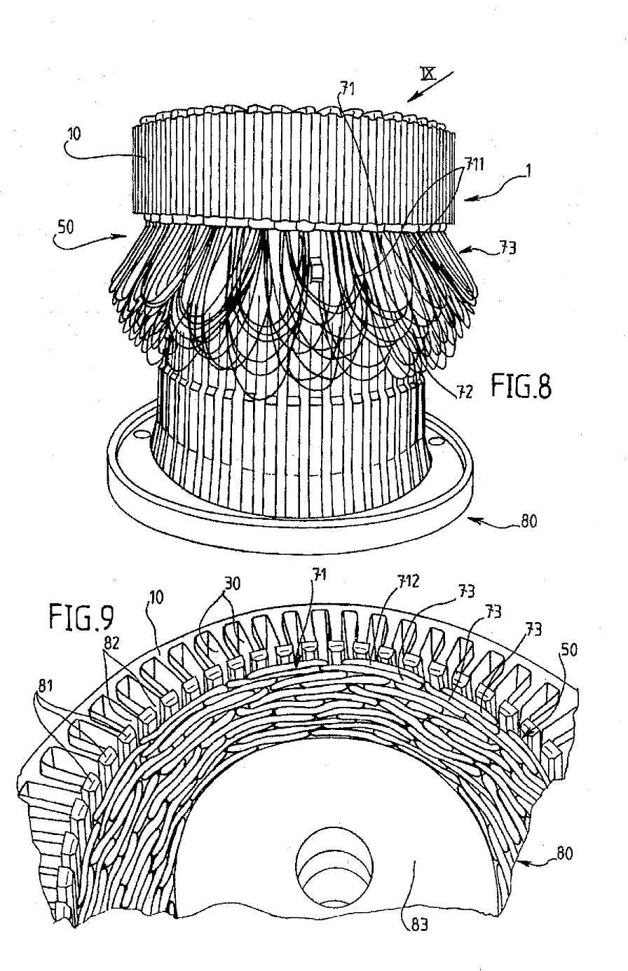

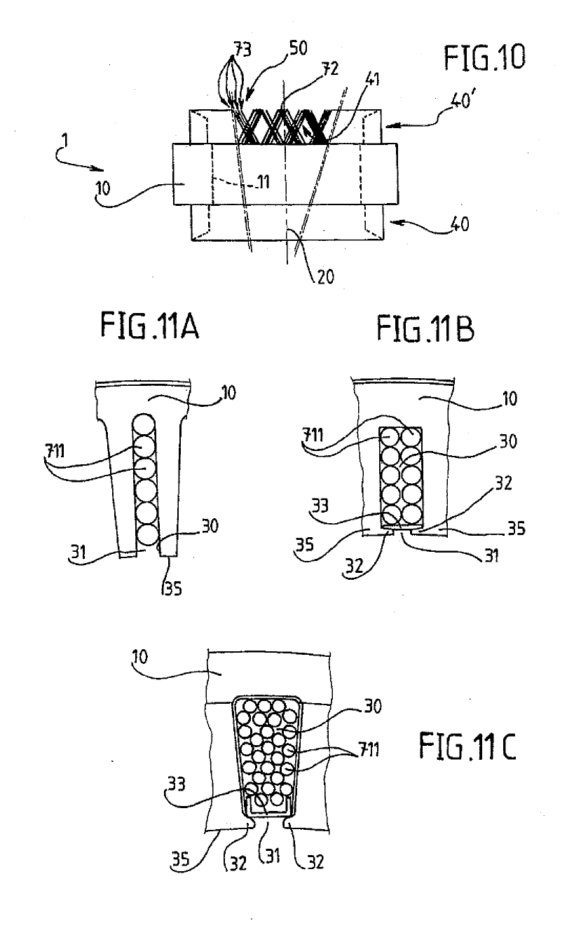

The lateral branches 711 of these turns 73 occupy progressively radially more internal positions in the recesses as the turns 73 are inserted, as illustrated in FIGS. 7A and 7B.

According to the invention, the wires 60 of all the windings 70 are inserted in the recesses 30 at the same time, the turns 73 of the various wires 60 alternating in the predetermined order of radial superimposition around the stator.

In a particularly advantageous embodiment, the order of superimposition comprises a succession of identical sequences, each sequence consisting of a turn 73 of each wire 60.

After insertion of the turns 73 in the recesses 30 at step 3/, there is then found in the stator, from outside towards the inside, a first sequence of turns 73 comprising a turn 73 of each wire 60, then a second sequence of turns identical to the first, then a third, etc, as illustrated in FIG. 13.

This order of superimposition is typically obtained by winding in a spiral a stack consisting of the various superimposed wires 60, as shown by FIG. 12.

The recesses 30 occupied by the lateral branches 711 of the turns of a given wire 60 are offset angularly with respect to the recesses 30 occupied by the lateral branches 711 of the turns of the other wires 60.

Because of this, in the coil ends 40, 40′, the head branches 712 and the connection segments 72 of the turns in one and the same sequence are not aligned radially but on the contrary offset angularly with respect to one another, as can be seen in FIG. 2B and in FIG. 13.

As a result the head branches 712 and the connection segments 72 of the turns do not, in the coil ends 40, 40′, constitute compact blocks opposing the circulation of cooling air for the rotary electrical machine.

A description will now be given of two embodiments of the method of the invention, differing through the way in which the insertion of the turns 73 in the recesses 30 is effected.

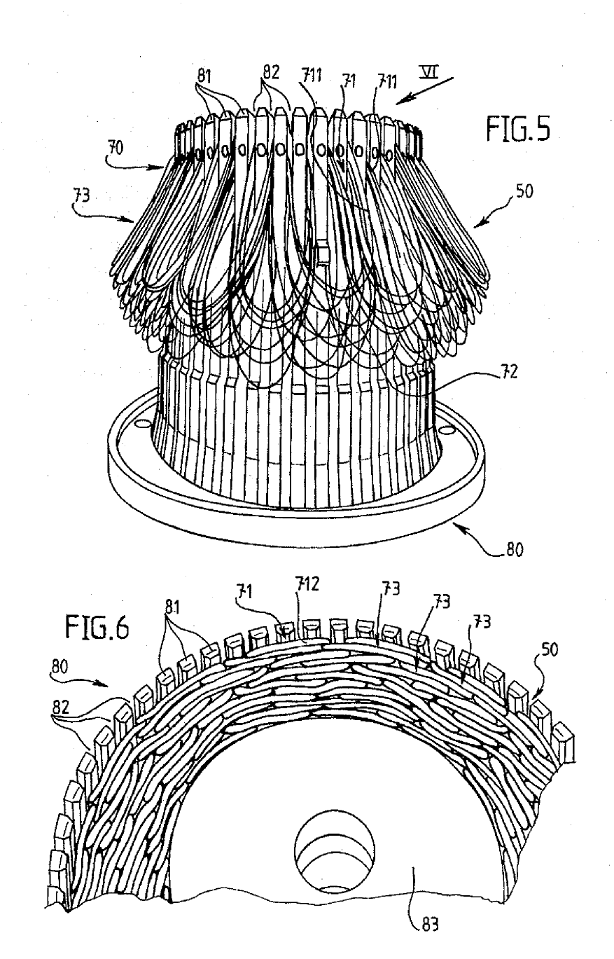

The first embodiment is illustrated in FIGS. 5 to 9.

The method comprises, between steps 1/ and 3/, the following step 2/:

2/ Fitting the wires 60 on a cylindrical insertion tool 80, the turns 723 of the wires 60 coiling around the insertion tool 80 whilst being superimposed radially from inside to outside in the predetermined order of superimposition, as can be seen in FIG. 12.

At step 3/, the insertion of the wires 60 in the recesses 30 is effected by movement of the insertion tool 80 along the axis of symmetry 20 of the stator 1. The turns 73 are transferred in reverse order to the order of winding on the tool, the turns 73 situated radially to the outside being inserted first and occupying the bottoms of the recesses 30, and the turns 73 situated radially to the inside being inserted last and being disposed close to the openings 31 of the recesses 30.

It can be seen in FIG. 5 that the insertion tool 80 comprises a plurality of fingers 81 parallel to the axis of symmetry of the tool, disposed in a circle, having free ends turned towards a top axial side of the tool, these fingers being separated by interstices 82.

When the windings are put in place at step 2/, the windings 70 are disposed on the insertion tool so that the lateral branches 711 of each crenellation 71 are each disposed in an interstice 82 and extend essentially outside the circle, the head branch 712 connecting the lateral branches by a side internal to the circle, the connection segments 72 connecting the crenellations by a side external to the circle.

The turns 73 are slipped, by the top side of the tool 80, onto the free ends of the fingers 81, and are superimposed parallel to the axis of symmetry of the insertion tool 80, the turns fitted first being disposed on the bottom side and the turns fitted last being disposed on a top side of the tool 80.

The interstices 82 are equal in number to the recesses 30.

The windings 70 are coiled around the insertion tool 80 at the same time at step 2/, the result of which is that the turns 73 that follow each other in the given order of winding belong alternatively to the various windings 70.

According to another characteristic of the invention, visible in FIG. 5, the crenellations 71 extend in respective planes parallel to the axis of symmetry of the insertion tool 80, or slightly inclined with respect to this axis, once the turns 73 are wound on the insertion tool 80.

This characteristic is particularly important because step 3/ of insertion of the windings 70 in the recesses 30 is performed by moving the insertion tool 80 along the axis of symmetry 20 of the stator 1.

The fingers 81 define the outside diameter of the tool 80, this diameter being slightly smaller than the inside diameter of the packet of metal sheets 10.

As shown in FIGS. 7A and 7B, the tool 80 comprises, apart from the fingers 81, a mushroom 83 able to move axially at the centre of the cylinder formed by the fingers 81. The mushroom 83 has an outside diameter practically equal to the inside diameter of the cylinder formed by the fingers 81.

The insertion tool 80 is disposed under the second axial side of the stator 1, its top end being turned upwards.

The tool 80 moves upwards in order to insert the turns 73, the fingers 81 and the mushroom 83 move in parallel during a first phase of insertion of the lateral branches 711 in the recesses 30, and then during a second phase the fingers 81 remain immobile while the mushroom 81 continues to move.

During the first phase, the mushroom 83 moves at the same speed as the fingers 81. The lateral branches 711 enter the recesses 30 from the bottom and slide upwards along the recesses 30. It is first of all a portion of each lateral branch 711 extending immediately outside the fingers 81 that engages in the corresponding recess 30 and then, progressively with the movement of the insertion tool 80 upwards, the whole of the lateral branch 711 from the fingers as far as the connection segment 72.

The first phase ends when the free ends of the fingers 81 arrive at the axial face of the packet of metal sheets 10 turned towards the first side.

The fingers 81 are immobilised, and the mushroom 83 continues to move, so that it pushes the branches of the head 712 axially upwards, as shown by FIG. 9.

The mushroom 83 pushes directly on the head branches 712 of the turns 73 situated lowest, these head branches 712 transmitting this force to the turns situated higher. It will therefore be understood that the mushroom 83 pushes all the turns 73 and that the latter are all inserted in the recesses in a single operation.

This movement has a dual effect. It makes it possible to make the head branches 712 tilt above the free ends of the fingers 81, these branches coming to be placed axially in line with the packet of metal sheets 10. The branches of the turns 73 situated at the top tilt first, and the branches of the turns 73 situated at the bottom tilt last.

It also makes it possible to pull the connection segments 72 axially in order to lock them in position on the second side of the packet of metal sheets 10 and form the coil end 40′.

Because the crenellations 71 of the windings 70 are disposed on the insertion tool 80 in planes practically parallel to the axis of symmetry of this tool, the lateral branches 711 undergo practically no torsion when they are inserted in the recesses 40 and the head branches are tilted above the free ends of the fingers 81.

Moreover, the sequencing of the turns 73 around the insertion tool 80 allows a very effective transmission of the thrust force from the mushroom 83 to the turns 73 furthest away from it, that is to say to the turns 73 disposed highest on the insertion tool 80.

This is because the order of winding of the turns 73 makes it possible to ensure that each head branch 712 of a turn comes into abutment on at least two head branches 712 of the immediately higher turn, each of these two head branches 712 coming into abutment on two other head branches 712 of the still higher turn, and so on. The thrust force is thus very well distributed circumferentially around the insertion tool.

As all the windings 70 are inserted in a single operation, the mushroom must be able to exert a high thrust force on the head branches 712. For this purpose, the insertion tool 83 is provided with two actuators, a bottom actuator that pushes the mushroom upwards and a top actuator that pulls it upwards. The mushroom 83 thus has the necessary power available for effecting the placing of the head branches 712 correctly.

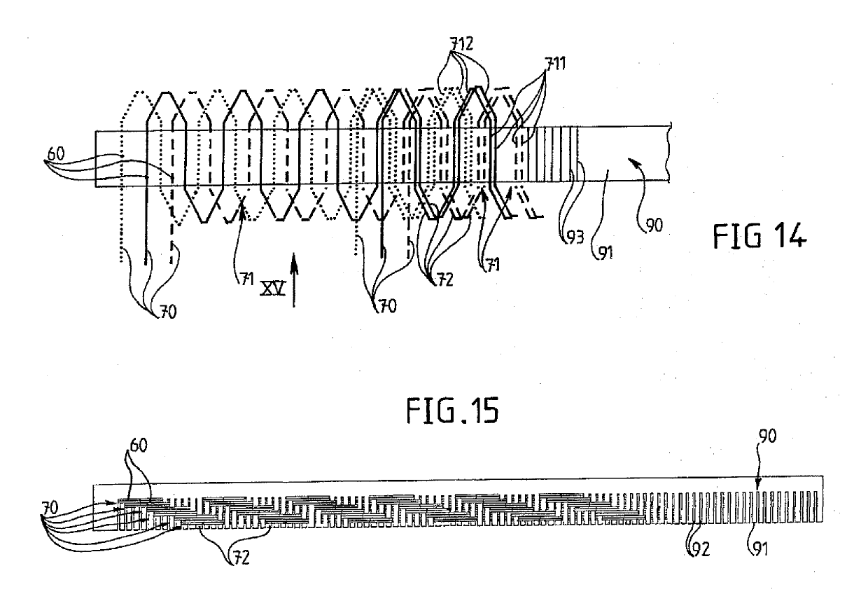

The second embodiment of the method of the invention is illustrated in FIGS. 14 to 21.

As can be seen in FIGS. 14 and 15, step 1/ comprises a first substep during which the wires 60 of the windings 70 are each conformed in a succession of longitudinally aligned crenellations 71, and a second substep following the first during which the wires 60 are stacked flat on a rectilinear longitudinal rack 90 having a first flat face 91 in which transverse slots 92 are formed.

These transverse slots 91 are regularly distributed in the longitudinal direction along the rack and have a constant mutual longitudinal separation. They extend in respective planes perpendicular to the longitudinal direction and mutually parallel.

As shown by FIG. 3, the winding 70 at the end of the first substep extends in a general longitudinal direction, the lateral branches 711 all extending substantially transversely and all being disposed parallel to one another in a longitudinal alignment.

As can be seen in FIG. 3, all the lateral branches 711 have the same length transversely. In addition, the pole pitch, that is to say the longitudinal separation separating two consecutive lateral branches 711 in the alignment, is constant along all the wire 70. Exceptionally, two lateral branches 711 can be separated by different pitch, at singular points on the wire 60.

The lateral branches 711 of the crenellations 71 of each wire 60 come to be inserted in a series of lateral slots 92.

The head branches 712 of the crenellations 71 are all disposed on the same side of the rack 90 and are curved, these head branches being concave on the side where the lateral branches 711 are.

The connection segments 72 are disposed on a side of the rack 90 opposite to the head branches 712 and also have a curved shape with their concavity turned towards the lateral branches 711.

FIG. 15 shows that the wires 60 are superimposed on the rack 90.

It was seen above that the said radial order of superimposition of the turns 73 around the stator 1 preferably consists of a succession of identical sequences, this sequence comprising a turn 73 of each wire 60.

The wires 60 are superimposed on the rack 90 in an order corresponding to that of the said sequence.

As in the first embodiment, the method comprises, between steps 1/ and 3/, the step 3/ of placing the wires 60 on a cylindrical insertion tool 80, the turns 73 of the wire 60 being wound around the insertion tool 80 while being superimposed radially from inside to outside in the said predetermined order of superimposition.

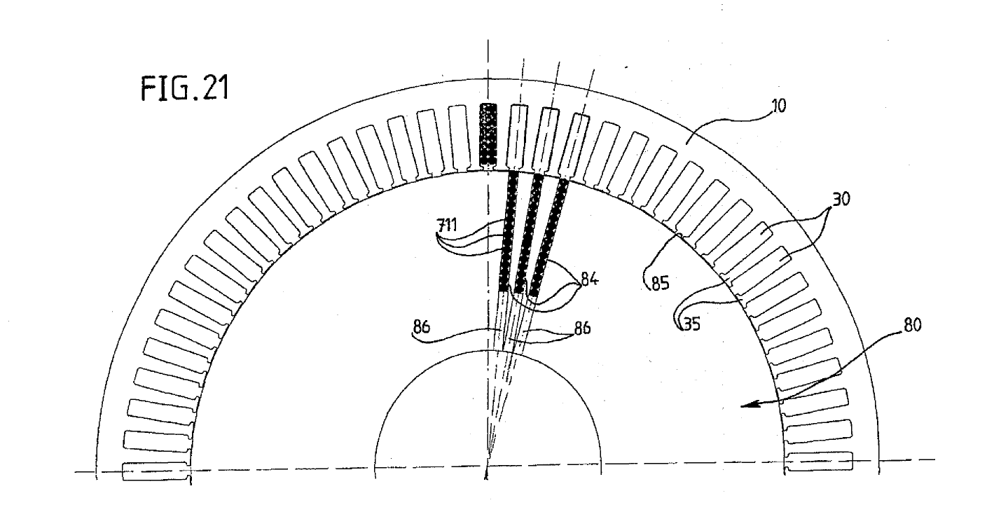

It can be seen in FIGS. 20 and 21 that the insertion tool 80 comprises, in this second embodiment, a cylindrical part 88 having a radially external face 85 in which there are formed a plurality of radial slots 84 extending in respective radial planes regularly distributed around an axis of symmetry of the tool 80, a plurality of blades 86 disposed in the radial slots, and means 87 of moving the blades 86 radially from inside to outside in the radial slots 84.

The radial slots 84 are equal in number to the number of recesses 30.

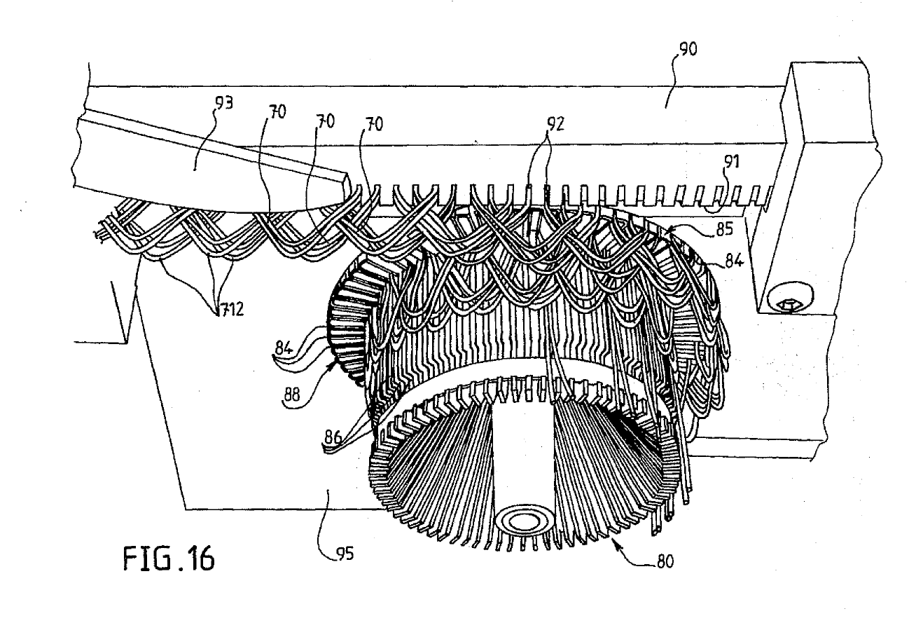

At step 2/, the stack formed by the wires 60 is wound from the rack 90 around the insertion tool 80 as shown in FIG. 16.

For this purpose, the rack 90 is made to travel along the tool 80, the first face 91 carrying the transverse slots 92 passing substantially tangentially to the external face 85 of the tool 80, this tool being driven at the same time in a rotation movement about its axis.

The transverse slots 92 all pass successively at the point of tangency between the rack and the tool, the radial slots 84 also passing at this same point. The movements of the rack 90 and of the tool 80 are synchronised so that the radial slots 84 and the transverse slots travel at the same speed at the tangent point.

Fixed cams 93 disposed on the two opposite transverse sides of the rack 90, close to the tool 80, urge the windings 70 towards the tool 80 in a radial direction with respect to the latter. These cams 93 are disposed slightly upstream of the tool 80 in the direction of travel of the rack, and bear on connection segments 72 and on the head branches 712.

Under the effect of the cams 93, the lateral branches 711 disposed in the transverse slot 92 arriving at the point of tangency slide in the radial slot 84 situated at the same moment at this point of tangency.

The tool 80 makes several turns while the rack 90 travels.

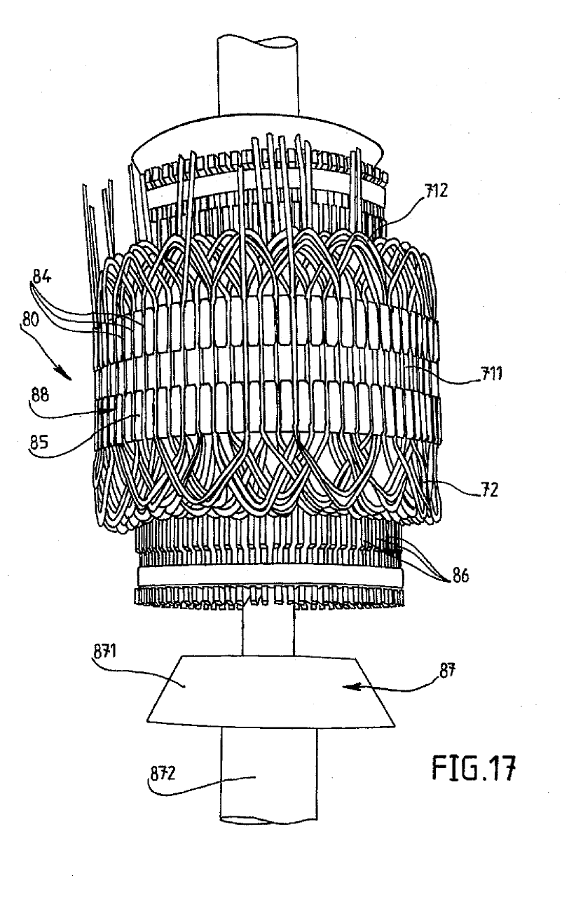

The state of the tool at the end of step 2/ is shown in FIG. 17.

It should be noted, as can be seen in FIG. 16, that the tool 80 turns inside a housing 94 in the form of a disc formed in a support 95, this housing 94 having a diameter corresponding to that of the tool 80. This housing 94 is open over an arc of a circle of approximately 45°, the point of tangency between the tool and the rack being situated substantially at the centre of this arc of a circle. The internal face of the housing 94 keeps the turns 73 engaged inside the radial slots 84.

During step 2/, the blades 86 are disposed at the bottom of the radial slot 84, the lateral branches 711 of the turns 73 coming to be inserted in these radial slots 84 on a radially external side of the blade 84 as can be seen in FIG. 21.

It should be noted that each radial slot 84 has a circumferential width corresponding to the cross-section of the wire of the windings, so that the lateral branches 711 are all aligned radially in the slot 84.

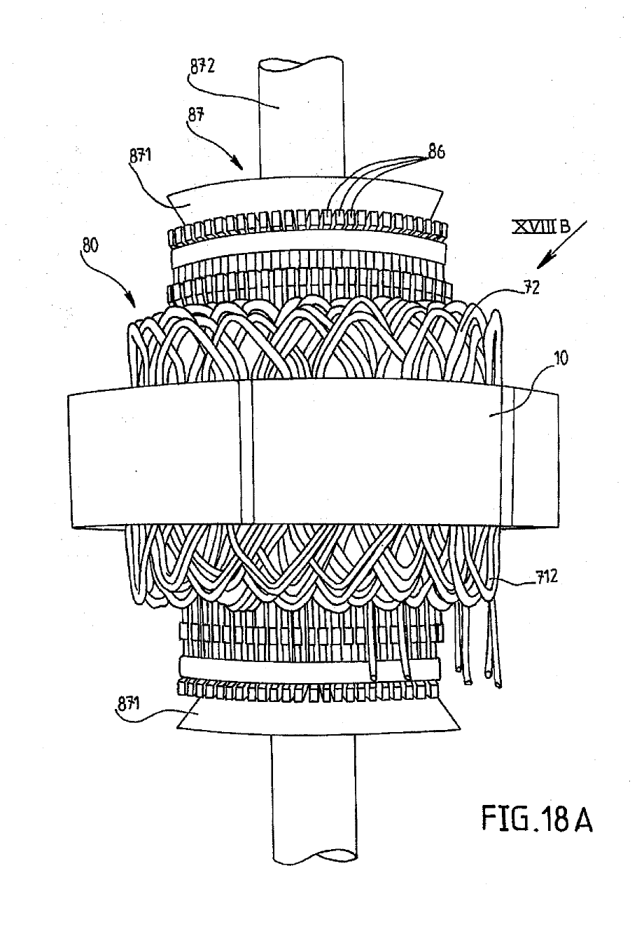

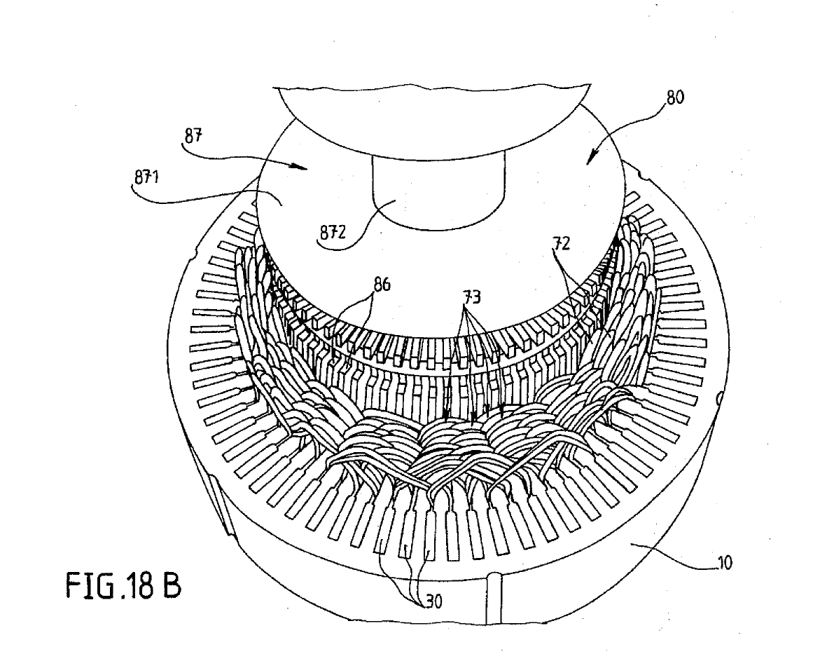

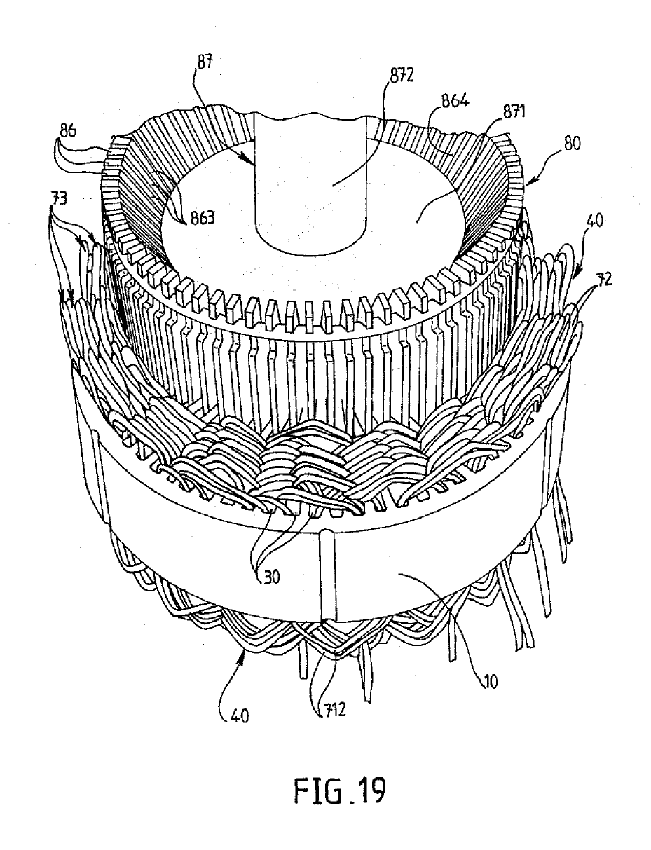

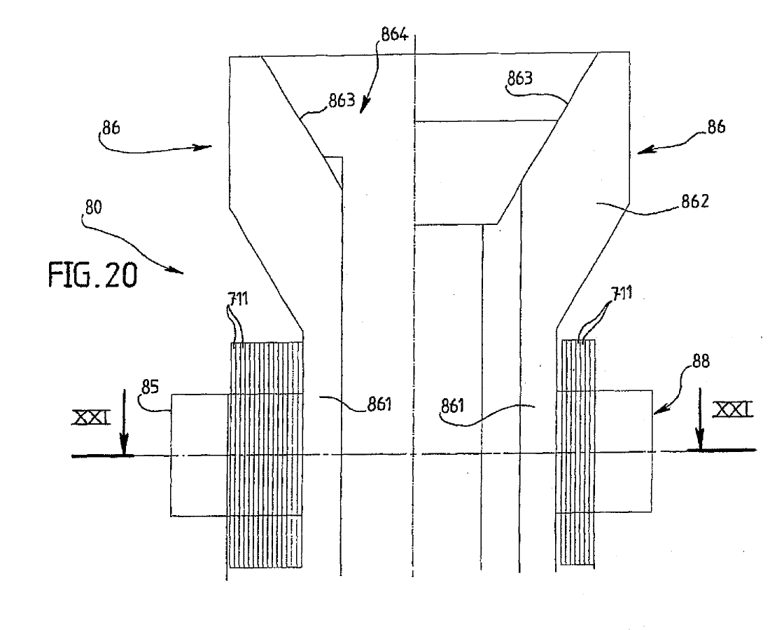

At step 3/, the insertion of the windings 70 in the recesses 30 is performed by disposing the insertion tool 80 at the centre of the packet of metal sheets 10 (FIGS. 18A and 18B), so that each radial slot 84 is situated opposite a recess 30, and by forcing the turns 73 radially in the recesses 30 from inside to outside.

For this purpose, the blades 86 are moved radially towards the outside by the means 87 provided for this purpose.

As shown by FIG. 20, each blade 86 extends in a radial plane with respect to the axis of the tool 80 and comprises a central part 861 engaged in one of the radial slots 84, and two end parts 862 axially extending the central part 861 on the two sides of the cylindrical part 88.

The end parts 862 of the blades 86 are delimited on a radially internal side by bevelled edges 863, so that the bevelled edges 863 of the various blades define on each side of the cylindrical part 88 a hollow truncated cone 864, converging towards the said cylindrical part 88, coaxial with the axis of symmetry of the tool 80.

The means 87 of moving the blades 86 comprise two pushers 871 in a truncated cone able to move along the axis of symmetry of the tool 80, and actuators 872 to move the said pushers 871 axially.

The pushers 871 have shapes conjugate with those of the hollow truncated cone 864.

The actuators 872 consist typically of jacks each provided with an axially movable rod, the pushers being fixed to the rods. The jacks are able to move the rods in order to apply the pushers 871 axially against the bevelled edges 861 forming the hollow truncated cones 864, these pushers thus urging the blades 86 in the direction of a separation towards the outside. The movement of the pushers or blades is visible by comparing FIGS. 18B and 19.

The central parts 861 of the blades 86 then push the lateral branches 711 of the turns 73 in the recesses 30, all the turns 73 thus being put in place on the stator 1 in a single operation (FIG. 19).

In this embodiment, the parallelism of the lateral branches 711 is particularly will controlled throughout the various steps. These branches are held parallel on the rack 90, and then in the radial slots 84 of the insertion tool 80, and then during the transfer from the tool to the recesses 30.

Moreover, the actuators 872 making it possible to separate the blades 86 are offset and are not situated at the centre of the tool 80. This is a significant advantage because the size of the stator tends to reduce.

Finally, the radial insertion of the turns makes it possible to put the turns in place without torsion thereof during insertion, so that they do not deform in return once the insertion is ended.

According to another aspect of the invention that is particularly advantageous, the head branches 712 and the connection segments 722 formed at step 1/ have axial heights increasing or decreasing along the windings 70.

The turns 73 intended to be inserted first in the recesses 30 and whose lateral branches 711 are inserted in radially external positions of bottoms of recesses 30, have at the end of step 1/ head branches 712 and connection segments 72 of relatively greater transverse heights than those of the turns 73 whose lateral branches 711 occupy radially internal positions.

In the example in FIG. 3, all the head branches 712 and the connection segments 72 of the same turn have the same height.

This height decreases regularly from one turn 73 to the following along the wire 60.

It was stated above that the pole pitch between two lateral branches 711 was the same all along the winding. This is necessary so as to form between the branches 711 a constant separation corresponding to the separation between the openings of the recesses 30 in which these branches are inserted.

The difference in height between the head branches 712 and the connection segments 72 of the various turns 73 of the same wire compensates for the fact that the successive lateral branches 711 of an external turn, disposed at the bottom of recesses 30, are mutually more separated than the lateral branches 711 of an internal turn, the branches of which are disposed at the entry to recesses 30.

Once the turns are inserted in the packet of metal sheets 10, the head branch 712 or the connection segment 72 connecting the two external branches 711 will be more open that the head branch 712 or connection segment 72 connecting the two internal branches 711. Because of its greater opening it will undergo a flattening that will return it to the same height as the head branch 712 of the connection segments 72 connecting the two internal branches 711.

In this way coil ends are obtained where all the elements have the same axial height, as shown by FIG. 2B.

The variation in transverse height of the turns 73 along a wire 60 that has just been described, and which aims to compensate for the difference in separation between the branches 711 of the external and internal turns, can be combined with another variation in transverse height of the turns, intended to obtain staged coil ends.

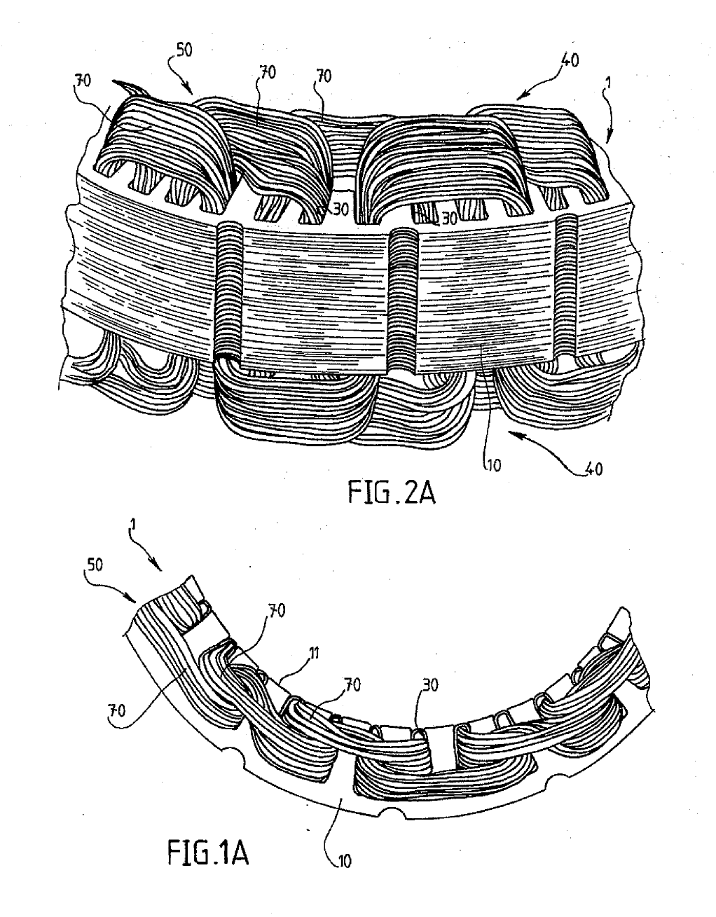

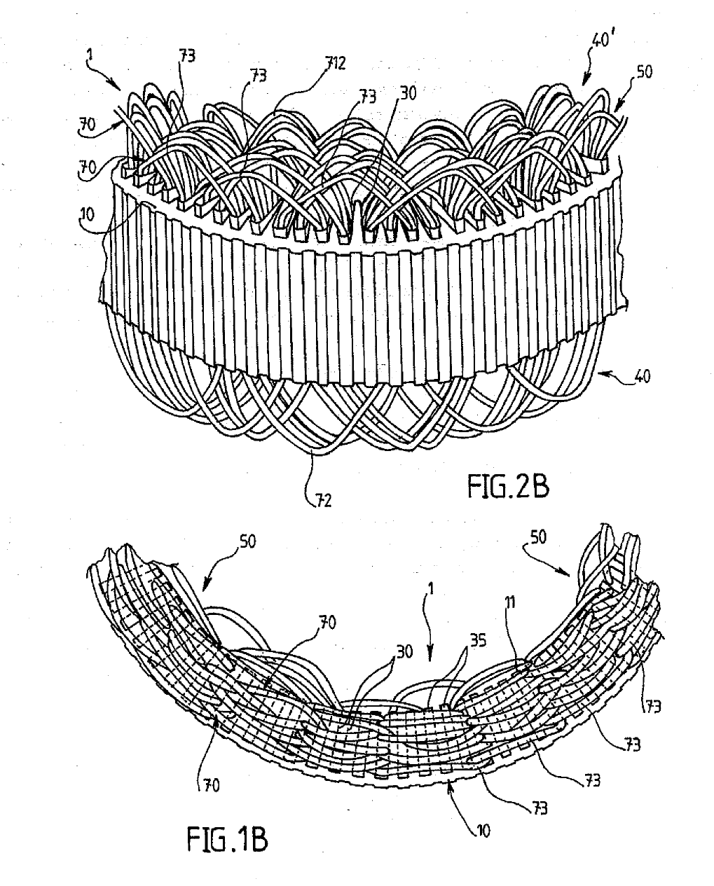

This other variation, which is added to the first, means that the head branches 712 or connection segments 72 of the same coil end will have a height increasing or decreasing from outside to inside. The stator of the prior art shown in FIG. 1A has such a staging of the head branches 712 and connection segments 72 of its coil ends. This configuration of the coil ends promotes cooling.

A closed result can be obtained using a stator whose coil ends consist of elements of the same height, by adding after step 3/ a step 4/ of shaping the coil ends by mechanical inclination of the connection segments 72 and/or the head branches 712 towards the inside or towards the outside.

This inclination is achieved for example by means of a jaw moved radially inwards or outwards and deforming the connection segments 72 and/or the head branches 712.

According to another advantageous characteristic, the method comprises, between steps 1/ and 2/, a step 1′/ of local shaping of the wire 60 in areas 61 of this wire intended to cross other wires 60 or other areas of the same wire, once the windings 70 are inserted in the stator.

These areas 61 are marked by circles in FIG. 4.

The local shaping of the wire 60 consists of locally deforming the cross-section of the wire 60, or locally curving the wire 60.

The deformation aims to locally flatten the section, in order to make it less thick in a given direction, but without reducing the total cross-section of flow of the current. The crossing areas 61 of the wires 60 are superimposed in the said given direction, so that the space requirement of the two stacked wires 60 is reduced. In the case of a wire 60 with a round cross-section, flattening typically leads to results in forming an oval cross-section.

The flattening of the area 61 can be achieved by pinching by means of adapted grippers, by swaging in a press equipped with an adapted mould, or by knurling using a rotary tool.

Conferring a local curvature on an area 61 of the wire 60 makes it possible to shift the crossing point of the wires to a less encumbered point on the coil end 40, where the space available is sufficient to allow the crossing of the wires 60.

This curvature is achieved by means of hooks locally deforming the wire by traction thereof.

It is known that the wire 60 typically has a round cross-section. So as to facilitate the storage of the lateral branches 711 in the recesses 30 and to increase the density of copper in these recesses, a circumferential width that is a multiple of the diameter of the wire is chosen for these recesses 30.

This width is typically equal to the diameter of the wire 60 or twice that diameter. In a variant the width of the recess is greater than twice the diameter of a wire, for example three to four times the diameter.

In a case where the recesses 30 have a circumferential width corresponding to the diameter of the wire 60, the lateral branch 711 occupying the radially innermost position, that is to say closest to the internal periphery of the packet of metal sheets 10, is deformed by broadening in a circumferential direction, as shown in FIG. 11A. The said lateral branch 711 is in abutment on the two opposite radial faces of the recess and is thus locked in position in the recess 30. The lateral branches 711 occupying the other positions are thus held inside the recess 30.

This deformation is carried out after the insertion step 3/, typically at three points on the lateral branch 711. It results in transforming the round cross-section of the wire into an oval cross-section.

In the case where the recesses 30 have a circumferential width equal to at least two diameters of the wire 60 (FIG. 11B), these recesses 30 have on a radially internal side an opening 31 partially closed off on two opposite sides by two axial steps 32, also referred to as tooth roots, projecting from the teeth 35. The lateral branches 711 occupying each recess 30 are held inside it by a flat shim 33 in abutment on the steps 32 on an internal side of the recess 30, as shown by FIG. 11B.

This shim 33 extends over the entire axial length of the recess 30 and has a rectangular shape.

The shim 33 is preferably formed from a plastic material containing a magnetic material, in particular iron, so as to increase the stator/rotor exchange surface area.

In the case of a radial insertion of the turns in the recesses, according to the second embodiment of the invention, it is possible to provide for the opening 31 to have a circumferential width equal to the diameter of the wire plus a clearance of less than 0.6 millimetres. This can be achieved because of the great precision of the positioning of the lateral branches 711 of the turn 73 at the time of their transfer from the insertion tool 80 to the recesses 30. In this way the stator/rotor exchange surface area is increased further. An opening 31 with a circumferential width equal to the diameter of the wire plus 0.4 millimetres will preferably be chosen. By comparison, in the prior art a circumferential width equal to the diameter of the wire plus 1 millimetre is generally chosen.

It should be noted that, in the case of recesses 30 with a width corresponding to a diameter of the wire 60, it is not necessary for the teeth 35 to carry steps 33 and the shims 33 can be omitted. In this way the construction of the packet of metal sheets 10 and the method of inserting the windings 70 in the recesses 30 are simplified.

Finally, still for the reason of facilitating the storage of the lateral branches 711 in the recesses 30, the recesses 30 can have a radial depth that is a multiple of the diameter of the wire 60.

As shown by FIGS. 11A and 11B, the dimensions chosen for the recesses 30 mean that the lateral branches 711 of the wire 60 normally come to be stored in several well ordered radial alignments at the step 3/ of insertion in the recesses 30.

It can also be emphasised that, in the case of a hexaphase stator, the coil of which comprises six phase windings 70 each consisting of a wire 60, distributed in three pairs, it is particularly advantageous to provide for the position on the stator of the turns 73 of a wire 60 of the same given pair to be derived from the position of the turns 73 of the other wire 60 in the same pair by a rotation corresponding to a shift by one notch 30, and that the position of the turns 73 of the wires 60 of a pair to be derived from the position of the turns 73 of the wires 60 of another pair by a rotation corresponding to an offset of two or four recesses 30.

In the case where the insertion of the turns 73 in the recesses 30 is performed radially, this arrangement of the turns 73 on the stator corresponds to the arrangement of the windings 70 on the rack illustrated in FIG. 15.

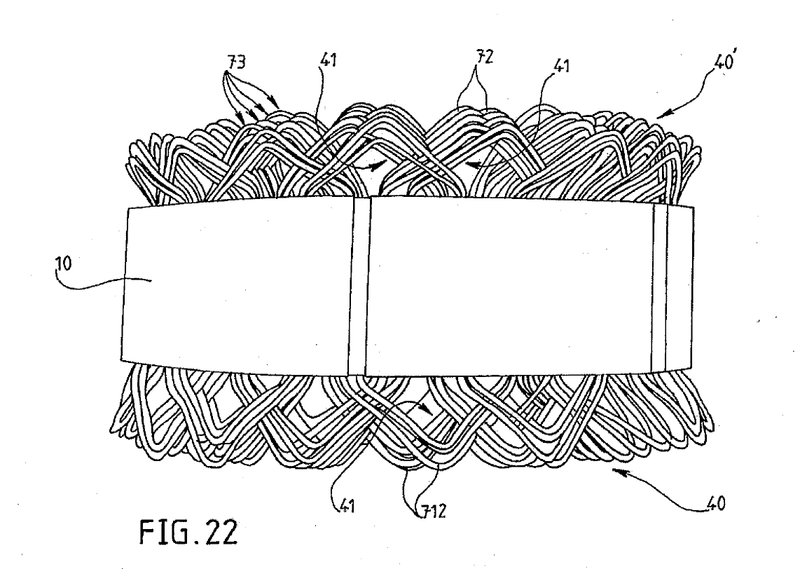

It makes it possible to obtain particularly well ventilated coil ends, like the ones depicted in FIG. 22. It can be seen in this figure that the head branches and the connection segments of each phase pair form wide circulation passages 41 for the cooling air, extending radially, these passages 41 being distributed around the stator.

It will therefore be understood clearly that the method described above procures many advantages.

The cycle time is short since the insertion of all the phase windings is performed in a single operation.

Moreover, the operations of preparing the windings are particularly meticulous and carefully done. Steps 1/ and 1′/ make it possible, at the end of the insertion step 3/, to obtain well ordered coil ends, having few defects. The downstream operations of quality control and defect correction are greatly accelerated, and the cycle time is reduced.

In the case of axial insertion, the formation of the coil ends takes place in good order because the thrust force of the mushroom is well transmitted from the turns disposed at the bottom on the insertion tool to the turns disposed at the top. This force is distributed evenly over the entire circumference of the tool.

In addition, still in the case of axial insertion, the method is adapted to existing toolings and requires only a few modifications to these.

In the case of radial insertion, the parallelism of the lateral branches 711 is particularly well controlled throughout the various steps. In addition, the turns undergo no deformation during the insertion step other than a slight flattening of the head branches and of the curved connection segments. Because of this, the positioning of the turns and the shape of the coil ends are particularly well controlled. Moreover, the position of the actuators 872, offset axially, makes it possible to deal with stators with a particularly small diameter.

The stators according to the invention also have advantages.

Because of the alternation of the turns of the various windings in the order of insertion order, the coil ends are particularly well ventilated. The cooling of the coil ends is thus greatly facilitated. The cooling air flow across the coil ends can then exceed 10 litres per second.

The conductive wires being, in the aforementioned manner, made from copper, the density of copper in the recesses can be increased up to 65%, this density being the ratio between the surface area of the cross-section of the non-insulated lateral branches to the cross-section of the non-insulated recess. This density is limited to 45% to 50% in the stators of the prior art.

This result is the combined effect of several aspects of the invention.

It is obtained first of all from the fact that the insertion of the lateral branches in the recesses is effected in an ordered fashion.

It also results from the good preparation of the wire crossing areas, which makes it possible to correctly store the coil end and therefore to correctly optimise the position of the lateral branches 711 in the recesses.

Finally, the choice of the dimensions of the recesses, the elimination of the shims or the use of shims with a rectangular shape and replacement for U-shaped shims of the prior art, also participates in the obtaining of this result.

It should be noted that, in the case of axial insertion, the substantially vertical positioning of the crenellations of the turns on the insertion tool makes it possible to achieve practically no deformation of the wire during insertion. Thus the crossing zones 61, which undergo a particular shaping before insertion, are not deformed and are correctly ordered in the coils ends of the rotor.

This remark is true also in the case of radial insertion, since the turns undergo practically no deformation during insertion.

The method described above is adapted to stators comprising any number of recesses and to coils comprising any number of phase windings. It is particularly adapted to a stator comprising from 36 to 96 recesses, corresponding to a rotor with 12 to 16 poles, and to a coil comprising 3 to 6 phase windings.

The method is adapted to all wire diameters and to all normal stator diameters for motor vehicle alternator stators.

It will be appreciated that the stator according to the invention is advantageously intended to be mounted in an alternator with an internal fan as described for example in the document EP-A-0 515 259. Such an alternator comprises a stator surrounding a rotor, for example a claw rotor or a rotor with projecting poles.

The rotor is fixed to a shaft mounted for rotation centrally by means of ball bearings in a casing in two parts called a front bearing and the rear bearing. The bearings are hollow and each have a bottom provided with openings, for forming air inlets, and a peripheral rim provided with openings for forming an air outlet. The bottoms of the bearings are roughly transversely oriented and carry at the centre a ball bearing for rotational mounting of the support shaft of the rotor. The bottoms are extended out their external periphery each by the peripheral rim roughly of axial orientation and shouldered for mounting the body of the stator carrying the coil with a plurality of phase windings, the coil ends of which extend in axial projection on each side of the body of the stator, and this below the openings of the peripheral rims of the bearings assembled for example by means of screws or tie rods, for forming the casing housing the stator and rotor. The rotor carries at least one of its axial ends a fan located radially below the coil end concerned. The rear bearing carries at least one brush holder, whilst a pulley, fixed to the support shaft of the rotor, is adjacent to the front bearing. For the other constituents of the alternator, reference should be made to the aforementioned document, knowing that the rotor with claws and excitation coil can be replaced by a stator with projecting poles carrying several excitation coils. A bridge rectifier, for example with diodes, is connected to the phase winding. In a variant, this bridge rectifier is conformed so as also to form an inverter, as described for example in the document FR-A-2 745 444, in order to inject current into the phase windings of the stator so as to make the alternator function as an electric motor, in particular to start the thermal engine of the motor vehicle, such an alternator being referred to as an alternator/starter.

In all cases, when the support shaft of the rotor turns, the fan or fans create an air flow between the air inlet and outlet openings passing over the coil ends of the coil according to the invention. More precisely, the step of preparing the wires separately, and then the step of organising the phase windings before they are inserted in the recesses, makes it possible to give the heads, referred to as coil ends, of the winding of the stator symmetrical characteristics making it possible to create in the coil ends air passage orifices and slopes that improve the circulation of air over the coil ends, for example above 10 litres per second.

Naturally, one coil end may in a variant may be higher axially than the other by virtue of the tool according to the invention.

Naturally, the recess insulators are placed and advantageously fixed in the recesses before the wires are inserted in the recesses. In FIGS. 11A and 11B the recess insulator visible in FIGS. 1A, 2B, 9 and 11C has not been shown for reasons of simplicity.

The cross-section of the conductive wires may be round, as in the figures, or square, or rectangular or elliptical or other.

The body of the stator is cylindrical in shape in the figures. In a variant the external periphery of the body of the stator is non-cylindrical in shape, for example in the form of a barrel. The recesses formed in each metal sheet in the packet of metal sheets are in a variant inclined with respect to the axial direction.

By virtue of the invention the polyphase rotary electrical machine equipped with the stator with a coil according to the invention is more powerful.

1. A method of inserting a corrugated coil in a stator of a rotary electrical machine, such as an alternator or an alternator/starter for a motor vehicle, the stator comprising a packet of metal sheets with a central hole and having an axis of symmetry and recesses passing through axially provided in a radially internal face of the packet of metal sheets, the coil comprising a plurality of phase windings each comprising at least one electrically conductive continuous wire, each wire being intended to form, around an internal face of said packet of metal sheets, a spiral comprising several turns each corresponding to a turn of said internal face, the method comprising the following steps:
forming each winding, each wire thereof being conformed in a succession of crenellations connected by connection segments, each crenellation comprising two lateral branches opposite each other intended each to be inserted in a recess, and a head branch connecting the two lateral branches;
inserting the turns of each wire in a series of recesses in the stator, the turns of the various wires being superimposed radially in a predetermined order;
wherein the wires of all the windings are inserted in the recesses at the same time, the turns of the different wires alternating in the predetermined order of superimposition.

2. The method according to claim 1, wherein said predetermined order of superimposition comprises a succession of identical sequences, each sequence consisting of a turn of each wire.

3. The method according to claim 1 wherein said recesses offer a plurality of radially staged reception positions, the lateral branches of the turns being superimposed from inside to outside in the said predetermined order progressively occupying reception positions radially more external in the recesses.

4. The Method according to claim 1, wherein said lateral branches of one and the same crenellation are substantially straight and mutually parallel.

5. The method according to claim 1, wherein said head branches of the crenellations are curved and form a coil end on a first axial side of the stator.

6. The method according to claim 5, wherein said connection segments connect two respective lateral branches of two adjacent crenellations along the wire and have a curved shape, these segments forming a coil end on a second axial side of the stator opposite to the first.

7. The method according to claim 6, wherein said head branches and/or the connection segments formed at said forming step have heights increasing or decreasing along the wires.

8. The method according to claim 7, wherein the turns whose lateral branches are inserted in radially external positions of bottoms of recesses have head branches and/or connection segments with heights relatively greater than the turns whose lateral branches are inserted at radially internal positions.

9. The method according to claim 6 wherein said method further comprises, after said inserting step, a step of shaping the coil ends by inclination of the connection segments and/or head branches inwards.

10. The method according to claim 6, wherein said method further comprises, after said inserting step, a step of shaping the coil ends by inclination of the connection segments and/or head branches outwards.

11. The method according to claim 1, wherein said method further comprises, after said forming step, a step of local shaping of the wires in areas of this wire intended to cross other wires, or other areas of the same wire, once the windings have been inserted in the stator.

12. The method according to claim 11, wherein the recesses have a circumferential width corresponding to the diameter of the wire, the lateral branch occupying the radially innermost position being deformed by broadening in a circumferential direction so as to hold the lateral branches occupying the other positions inside the recess.

13. The method according to claim 11, wherein said recesses have a circumferential width equal to at least two diameters of the wire and have on a radially internal side an opening partially closed off on two opposite sides by two axial steps, the lateral branches occupying the recesses being held inside it by a flat shim in abutment on the steps on an internal side of the recess.

14. The method according to claim 13, wherein said shim is formed from a plastics material containing a magnetic material, in particular iron.

15. The method according to claim 1, further comprising, between said forming step and said inserting step, the following step:
placing the wires on a cylindrical insertion tool, the turns of the wires coiling around the insertion tool while being superimposed radially from inside to outside in the said predetermined order.

16. The method according to claim 15, wherein on the insertion tool, the crenellations extend in respective planes parallel to the axis of symmetry of the insertion tool, or slightly inclined with respect to this axis.

17. The method according to claim 16, wherein said step of insertion of the windings in the recesses is performed by moving the insertion tool along the axis of symmetry of the stator.

18. The method according to claim 16, wherein the step of insertion of the windings in the recesses is performed by disposing the insertion tool at the center of the packet of metal sheets and forcing the turns radially into the recesses from inside to outside.

19. The method according to claim 18, wherein said insertion tool comprises a plurality of radial slots provided on a radially external face of the tool and extending in respective radial planes regularly distributed around an axis of symmetry of the tool, a plurality of blades disposed in the radial slots, and means of moving the blades radially from inside to outside in the radial slots, the lateral branches of the turns coming to be inserted in the radial slots at said placing step on a radially external side of the blades, the blades being moved radially towards the outside at said inserting step so as to transfer the lateral branches from the radial slots into the recesses.

20. The method according to claim 19, wherein at said forming step, after shaping the wires of the windings in a succession of longitudinally aligned crenellations, the wires of all the windings are stacked flat on a rectilinear longitudinal rack in which there are provided mutually parallel transverse slots, the lateral branches of crenellations of each wire coming to be inserted in a series of transverse slots.

21. The method according to claim 20, wherein at said placing step, the stack formed by the wires of the windings is coiled from the rack around the insertion tool.

22. The method according to claim 1, wherein the winding comprises six wires distributed in three pairs, the position of the turns of a wire of a given pair being derived from the position of the turns of the other wire in the same pair by a rotation corresponding to shift of one notch.

23. A stator for a polyphase rotary electrical machine, such as an alternator or an alternator/starter for a motor vehicle, said stator comprising a packet of metal sheets with a central hole and having an axis of symmetry, recesses passing through axially provided in a radially internal face of the packet of metal sheets and a winding comprising a plurality of phase windings each comprising at least one electrically conductive continuous wire, each wire forming around the internal face of the packet of metal sheets a spiral comprising several turns each corresponding to one turn of the internal face;
each wire being conformed in a succession of crenellations connected by connection segments, each crenellation comprising two lateral branches each coming to be inserted in a recess, and a head branch connecting the two lateral branches;
the turns of the wires being superimposed radially in a predetermined order;
wherein said turns of the various wires alternate in a predetermined order of superimposition.

24. The stator according to claim 23, wherein the predetermined order of superimposition comprises a succession of identical sequences, each sequence consisting of a turn of each wire.

25. The stator according to claim 23, wherein the recesses offer a plurality of radially staged reception positions, the lateral branches of the turns being superimposed from inside to outside in the said predetermined order progressively occupying reception positions radially more external in the recesses.

26. The stator according to claim 23, wherein the lateral branches of each crenellation are substantially straight and mutually parallel.

27. The stator according to claim 23, wherein the head branches of the crenellations are curved and form a coil end on a first axial side of the stator.

28. The stator according to claim 27, wherein the connection segments connect two respective lateral branches of two adjacent crenellations along the wire and have a curved shape, these segments forming a coil end on a second axial end of the stator opposite to the first.

29. The stator according to claim 28, wherein the connection segments and/or the head branches constituting the coil ends are inclined towards the inside.

30. The stator according to claim 28, wherein the connection segments and/or the head branches constituting the coil ends are inclined towards the outside.

31. The stator according to claim 23, wherein the wire is shaped locally in areas of this wire crossing other wires or other areas of this same wire.

32. The stator according to claim 23, wherein the recesses have a circumferential width corresponding to the diameter of the wire, the lateral branch occupying the radially most internal position being deformed by broadening in a circumferential direction so as to keep the lateral branches occupying the other position inside the recess.

33. The stator according to claim 23, wherein the recesses have a circumferential width equal to at least two diameters of the wire and have, on a radially internal side, an opening partially closed off on two opposite sides by two axial steps, the lateral branches occupying the recesses being kept inside this by a flat shim in abutment on the steps on an internal side of the recess.

34. The stator according to claim 33 wherein that the shim consists of a plastics material containing a magnetic material, in particular iron.

35. The stator according to claim 23, wherein the coil comprises six wires distributed in three pairs, the position of the turns of a wire in a given pair being derived from the position of the turns of the other wire in the same pair by a rotation corresponding to a shift by one notch.

36. The stator according to claim 35, wherein the position of the turns of the wires of a pair is derived from the position of the turns of the wires in the other pair by a rotation corresponding to a shift by four notches.

37. The stator according to claim 35, wherein the position of the turns of the wires of a pair is derived from the position of the turns of the wires in another pair by a rotation corresponding to a shift by two notches.

38. A method, comprising:
a) bending a wire into a serpentine shape which lies approximately on the surface of an imaginary cone;
b) moving the bent wire into the aperture of a stator of an electrical machine, which stator has
i) inwardly extending stator teeth surrounding the
ii) spaces between the teeth; and
c) expanding the bent wire into the spaces.

39. The method according to claim 38, wherein the serpentine shape includes loops of wire, and including the step of supporting the loops around fingers of an insertion tool.

40. The method according to claim 39, wherein the process of expanding includes a process of pushing the loops off the fingers.

41. A method of manufacturing an apparatus for an electrical machine, the apparatus containing
1) a radial array of inwardly extending teeth which surround an aperture;
2) slots between the teeth; and
3) a serpentine path defined through the slots for a wire to follow, the serpentine path lying on the surface of an imaginary cylinder, comprising:
a) bending a wire into a serpentine path which lies approximately on the surface of an imaginary cone, such that a first axial end of the serpentine path is of larger diameter than the other, second, axial end;
b) moving the wire into the aperture; and
c) expanding the second axial end.

42. A method of manufacturing an apparatus for an electrical machine, the apparatus containing
1) a radial array of inwardly extending teeth which surround an aperture;
2) slots between the teeth; and
3) serpentine wires intertwined through the slots, comprising:
a) generating one or more serpentine wires, which wrap around an insertion tool, wherein
i) a first axial end of the wires is bunched into a relatively small diameter; and
ii) a second axial end, opposite the first end, occupies a relatively larger diameter;
b) moving the insertion tool and the wires into the aperture, to thereby drag parts of the wires through slots;
c) stopping movement of the insertion tool when, or before, wires in the second axial end contact the teeth; and
d) expanding wires in the first axial end to a larger diameter.

43. The method according to claim 42, wherein, after the expanding of paragraph (d),
1) parts of the wires lie in the slots;
2) the first axial end lies axially outside a first side of the teeth; and
3) the second axial end lies axially outside a second side of the teeth, generally opposite the first side.

44. The method according to claim 42 wherein the first axial end comprises loops of wire which loop around fingers of the insertion tool.

45. A method of manufacturing a stator for an electrical machine, wherein
1) the completed stator comprises teeth which (A) define axially extending slots and (B) surround an aperture;
2) the slots contain lateral branch wires;
3) external connector-wires connect lateral branch wires together; and
4) the external connector-wires prevent removal of the lateral branch wires from their slots in the axial direction, comprising:
a) supporting loops from an insertion tool, each loop including
i) first and second external connector wires A and B held by the insertion tool;
ii) two lateral branch wires, each hanging from one of the two external connectors held by the insertion tool; and
iii) a third external connector wire C connecting the two lateral branch wires together;
b) moving the insertion tool and the loops into the aperture, until the third external connector C wire reaches a tooth, and
c) moving the first and second external connector wires A and B radially outward, until the two lateral branch wires seat into spaces.

46. A method, comprising:
a) generating a serpentine wire which follows a path which lies in a single plane;
b) wrapping the serpentine wire around an insertion tool;
c) placing the insertion tool within an array of inwardly extending teeth of a stator of an electrical machine, the teeth having spaces between them; and
d) causing the insertion tool to expand the serpentine wire, so that axial parts of the serpentine wire enter the spaces.

47. The method according to claim 46, wherein the insertion tool contains blades which the wrapped serpentine wire surrounds.

48. The method according to claim 47, wherein the blades are in registration with the spaces between the teeth and push the axial parts of the serpentine wire into the spaces.

49. The method according to claim 46, wherein slots are associated with the insertion tool, and the serpentine wire rests in the slots.

50. The method according to claim 49, wherein the slots prevent distortion of the serpentine wire.

51. The method according to claim 46, and further comprising:
a1) holding the flat serpentine wire in spaces of a rack or comb, prior to wrapping the flat serpentine wire around the insertion tool.
